(19) United States
(12) Patent Application Publication
(10) Pub. No.: US 2026/0285029 A1
(43) Pub. Date: Sep. 24, 2026

(54) ALIGNMENT TOOL USABLE FOR MARKING MACHINE COMPONENTS

(71) Applicant: Caterpillar Inc., Peoria, IL (US)

(72) Inventors: Spencer William Seeley, Chicago, IL (US); Adam Wontorcik, Cabot, AR (US); Ryan Majewski, Sycamore, IL (US)

(73) Assignee: Caterpillar Inc., Peoria, IL (US)

(21) Appl. No.: 19/085,304

(22) Filed: Mar. 20, 2025

(51) Int. Cl. B41F 33/02

(52) U.S. Cl. CPC B41F 33/02

(57) ABSTRACT

An alignment tool usable for marking a component includes a frame. The alignment tool also includes at least two retaining pins that are adapted to engage the frame of the alignment tool with the component. The alignment tool further includes a marked level patch to indicate an alignment of the alignment tool relative to the component when the component is not in its final orientation. The alignment tool includes at least one magnet coupled to a front surface of the frame. The at least one magnet is adapted to removably couple the frame with the component.

### TECHNICAL FIELD

The present disclosure relates to an alignment tool usable for marking a component and a method of coupling the alignment tool with the component for marking the component.

### BACKGROUND

An alignment tool is often used for marking a component. The alignment tool engages with a marking tool to provide markings on the component. In some examples, the component may be associated with a work machine such as, a wheel loader. The alignment tool may be used for marking serial numbers, texts, logos, and the like on the component.

Currently, an operator may face challenges in aligning the alignment tool relative to the component when the component is laying out of its final position on a floor. Further, the alignment tool may slip or may shift out of place during a marking process. Due to a design of conventional alignment tools, the operator may have to continuously monitor a position and/or alignment of the alignment tool relative to the component during the marking process, which may increase time and efforts required to complete the marking process.

WO2024188506 describes a mobile ink printing system for topographical marking of information on a surface of a construction, said system being adapted for being handled and moved with one hand of an operator, said system comprising:—a mobile printing carrier with a printing head;—a frame with a marking window and with guiding means adapted for guiding the movement of the mobile printing carrier;—at least one topographic positioning means;—a manual gripping means;—at least one control means determining or confirming at least the topographic position of the mobile printing carrier, and—an activating means for activating the printing head.

### SUMMARY OF THE DISCLOSURE

In an aspect of the present disclosure, an alignment tool usable for marking a component is provided. The alignment tool includes a frame. The alignment tool also includes at least two retaining pins that are adapted to engage the frame of the alignment tool with the component. The alignment tool further includes a marked level patch to indicate an alignment of the alignment tool relative to the component when the component is not in its final orientation. The alignment tool includes at least one magnet coupled to a front surface of the frame. The at least one magnet is adapted to removably couple the frame with the component.

In another aspect of the present disclosure, an alignment tool usable for marking a component is provided. The alignment tool includes a frame. The frame is adapted to engage with a marking tool to mark serial numbers or text on the component. The frame defines a tool receiving portion that is adapted to at least partially receive the marking tool. The alignment tool also includes at least two retaining pins that are adapted to engage the frame of the alignment tool with the component. The alignment tool further includes a marked level patch to indicate an alignment of the alignment tool relative to the component when the component is not in its final orientation. The alignment tool includes a level gauge coupled to the frame to further indicate a horizontal alignment of the alignment tool relative to the component when the component is not in its final orientation. The alignment tool also includes at least one magnet coupled to a front surface of the frame. The at least one magnet is adapted to removably couple the frame with the component.

In yet another aspect of the present disclosure, a method of coupling an alignment tool with a component for marking the component is provided. The method includes providing the alignment tool. The alignment tool includes a frame. The method also includes engaging, via at least two retaining pins of the alignment tool, the frame of the alignment tool with the component. The method further includes indicating, via a marked level patch of the alignment tool, an alignment of the alignment tool relative to the component when the component is not in its final orientation. The method includes indicating, via a level gauge of the alignment tool, a horizontal alignment of the alignment tool relative to the component when the component is not in its final orientation, wherein the level gauge is coupled to the frame. The method also includes removably coupling, via at least one magnet of the alignment tool, the frame with the component before the at least two retaining pins engage the frame of the alignment tool with the component. The at least one magnet is coupled to a front surface of the frame.

Other features and aspects of this disclosure will be apparent from the following description and the accompanying drawings.

### BRIEF DESCRIPTION OF THE DRAWINGS

FIG. 1 is a schematic view of a portion of a component and an alignment tool coupled with the component and a marking tool, according to an example of the present disclosure;

FIG. 2 is a schematic view of the alignment tool coupled to the component of FIG. 1;

FIG. 3A is a schematic front view of the alignment tool of FIGS. 1 and 2;

FIG. 3B is a schematic rear view of the alignment tool of FIG. 3A including a first retaining pin;

FIG. 3C is a schematic front view of the first retaining pin of FIG. 3B;

FIG. 3D is a schematic side view of the first retaining pin of FIG. 3C;

FIG. 4 is a schematic view of an alignment tool, according to another example of the present disclosure;

FIG. 5 is a schematic view of an alignment tool, according to yet another example of the present disclosure; and

FIG. 6 is a flowchart for a method of coupling the alignment tool with the component of FIG. 1 for marking the component, according to an example of the present disclosure.

### DETAILED DESCRIPTION

Wherever possible, the same reference numbers will be used throughout the drawings to refer to the same or like parts.

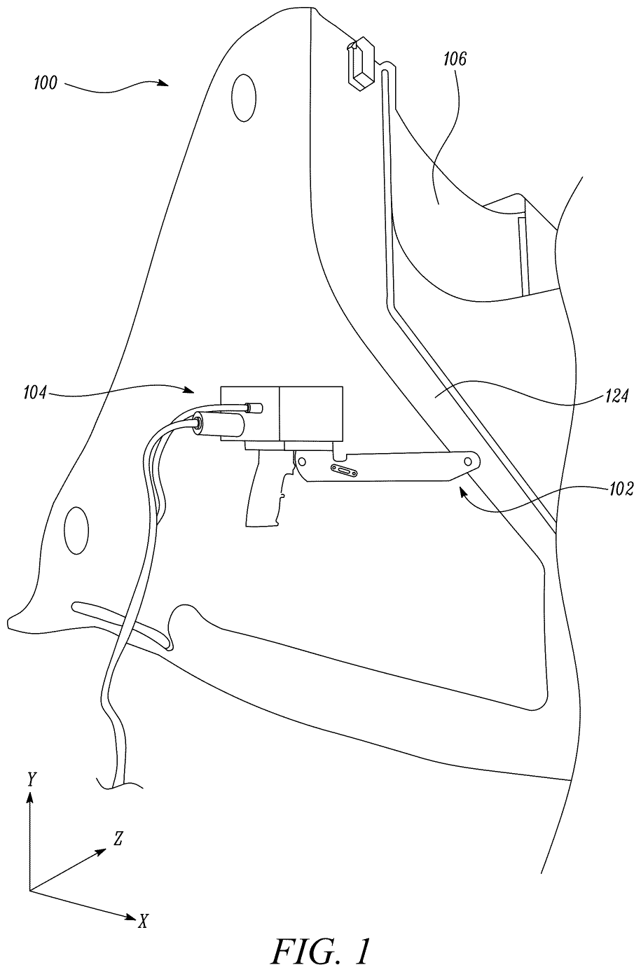

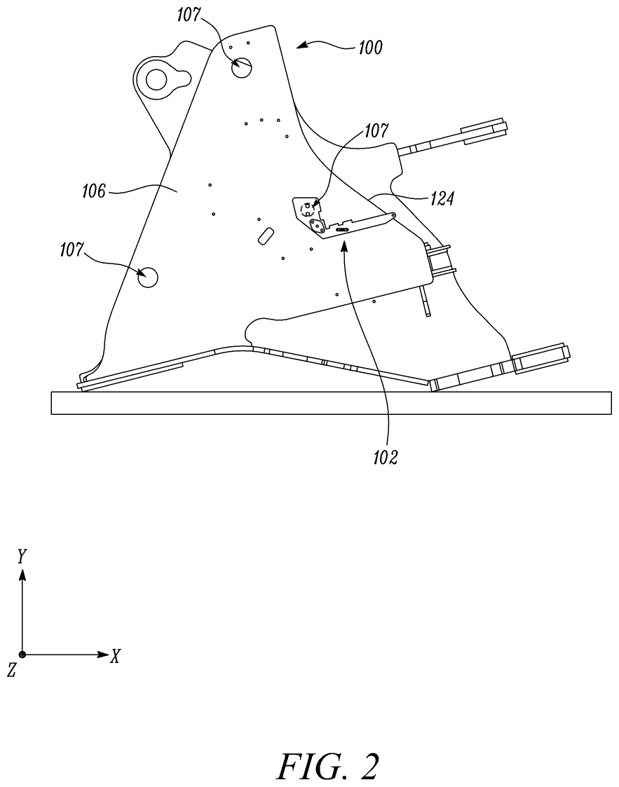

FIG. 1 is a schematic view of a portion of a component 100 and an alignment tool 102 that is usable for marking the component 100, according to an example of the present disclosure. The alignment tool 102 is coupled with the component 100. FIG. 1 also illustrates a marking tool 104 in engagement with the alignment tool 102. FIG. 2 is a schematic view of just the alignment tool 102 of FIG. 1 coupled with the component 100.

Referring to FIGS. 1 and 2, the component 100 is a frame 106 of a wheel loader (not shown). The frame 106 may be associated with a boom, a bucket, a stick, a chassis, and the like. It should be noted that the component 100 may embody any other component of a movable machine or a stationary machine. In various examples, the machine may or may not be associated with an automobile industry. It should be noted that the present disclosure is not limited to a type of the component 100 that can be marked by the marking tool 104 using the alignment tool 102.

The component 100 defines a number of openings 107. In the illustrated embodiment of FIG. 2, the component 100 is out of position. The term “out of position” as used herein means that the component 100 is not in its final orientation or position. In some examples, the component 100 may be in its final orientation after the component 100 is assembled.

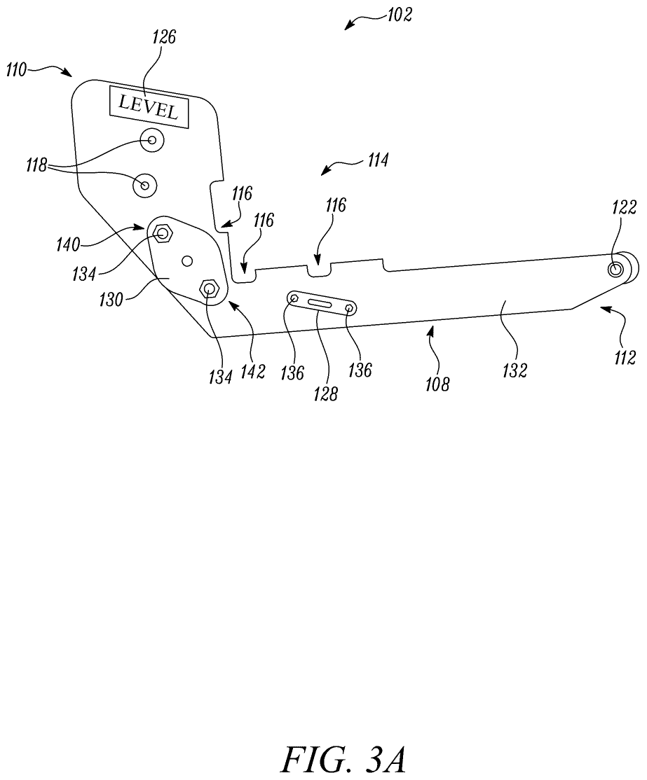

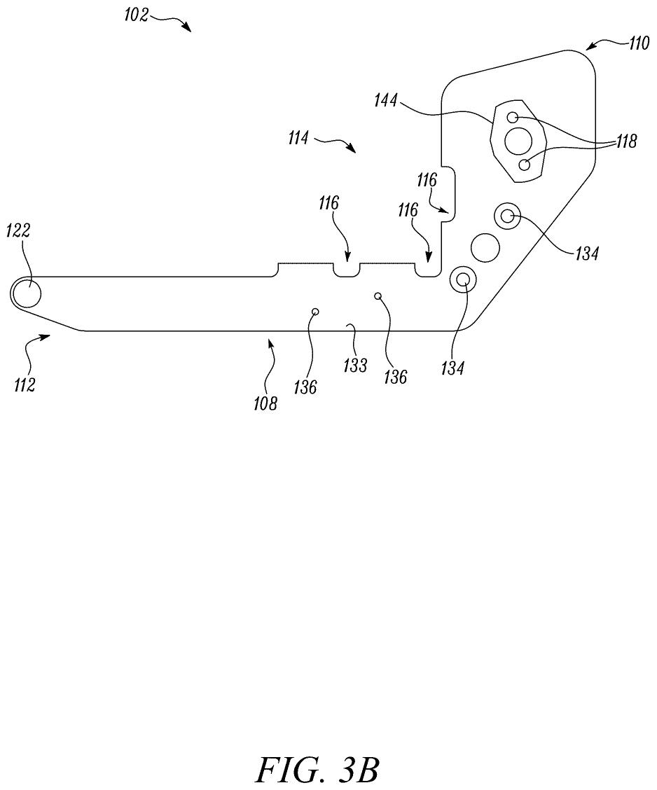

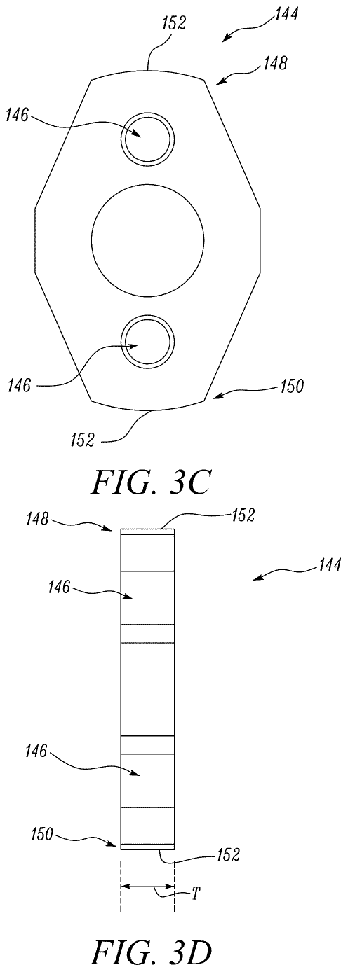

With reference to FIGS. 1 and 3A, the alignment tool 102 includes a frame 108. The frame 108 defines a first end 110 and a second end 112 opposite the first end 110. The frame 108 further defines a front surface 132 and a rear surface 133 (shown in FIG. 3B) opposite the front surface 132. When the alignment tool 102 is coupled with the component 100, the rear surface 133 of the frame 108 is in contact with the component 100.

Further, the frame 108 includes a truss-shaped design or an L-shaped profile. In the illustrated embodiment of FIGS. 1 and 3A, the frame 108 includes the L-shaped profile. However, the frame 108 may have any other shape, without any limitations. The frame 108 engages with the marking tool 104 for marking serial numbers or text on the component 100. In some examples, the marking tool 104 may mark logos, pictures, and the like on the component 100. It should be noted that the present disclosure is not limited to a type of marking that is to be done on the component 100.

Referring now to FIGS. 3A and 3B, the alignment tool 102 includes two or more retaining pins 144, 122. The two or more retaining pins 144, 122 engage the frame 108 of the alignment tool 102 with the component 100 (see FIG. 2). Specifically, as shown in FIG. 3B, the two or more retaining pins 144, 122 includes a first retaining pin 144. The two or more retaining pins 144 may be hereinafter interchangeably referred to as “the first retaining pin 144”. The first retaining pin 144 is disposed proximal to the first end 110 of the frame 108.

FIG. 3C is a schematic view of the first retaining pin 144. Referring to FIGS. 3B to 3D, the first retaining pin 144 is received into the opening 107 defined in the component 100 (see FIGS. 1 and 2) to engage the frame 108 of the alignment tool 102 with the component 100 (see FIGS. 1 and 2). The first retaining pin 144 is coupled to the rear surface 133 of the frame 108. The first retaining pin 144 has a thickness T and extends from the rear surface 133 of the frame 108. In some examples, outer surfaces 152 of the retaining pin 144 may engage with the component 100 to engage the alignment tool 102 with the component 100. Specifically, the first retaining pin 144 may snugly fit into the opening 107 defined in the component 100 such that the outer surfaces 152 of the first retaining pin 144 engages with an inner circumferential surface of the opening 107, thereby engaging the alignment tool 102 with the component 100. In the illustrated embodiment of FIG. 3B, a single first retaining pin 144 is shown. However, the alignment tool 102 may include any number of first retaining pins 144, as per application attributes.

The first retaining pin 144 has a rhombus shape. Alternatively, the first retaining pin 144 may have a circular shape, a triangular shape, or any other shape without any limitations. The first retaining pin 144 defines a pair of holes 146. Specifically, one hole 146 from the pair of holes 146 is defined at an end 148 of the first retaining pin 144 and another hole 146 from the pair of holes 146 is defined at an end 150 of the first retaining pin 144.

Referring now to FIGS. 3A to 3D, the alignment tool 102 also includes one or more first fasteners 118. The one or more first fasteners 118 are disposed proximal to the first end 110 of the frame 108. The one or more first fasteners 118 removably couple the first retaining pin 144 with the frame 108. Specifically, the frame 108 defines one or more first openings (not shown). The one or more first fasteners 118 are received in a corresponding first opening defined in the frame 108 and a corresponding hole 146 from the pair of holes 146 defined in the first retaining pins 144 to removably couple the first retaining pin 144 with the frame 108. In the illustrated embodiment of FIGS. 3A to 3D, the alignment tool 102 includes a pair of first fasteners 118 that are received into the pair of holes 146 to removably couple the first retaining pin 144 with the frame 108. Alternatively, the alignment tool 102 may include any number of first fasteners 118 based on application attributes.

Referring again to FIG. 3A, the two or more retaining pins 122 include a second retaining pin 122 extending from the rear surface 133 (see FIG. 3B) of the frame 108. The two or more retaining pins 122 may be hereinafter interchangeably referred to as “the second retaining pin 122”. One end of the second retaining pin 122 is coupled with the frame 108 and another end of the second retaining pin 122 is free. The second retaining pin 122 is disposed proximal to the second end 112 of the alignment tool 102. The second retaining pin 122 is positioned on a shoulder 124 (see FIGS. 1 and 2) of the component 100 (see FIGS. 1 and 2) to retain the frame 108 on the component 100. In the illustrated embodiment of FIG. 3A, a single second retaining pin 122 is shown. However, the alignment tool 102 may include any number of second retaining pins 122, as per application attributes.

The alignment tool 102 further includes a marked level patch 126 to indicate an alignment of the alignment tool 102 relative to the component 100 when the component 100 is not in its final orientation, or in other words, the component 100 is out of position. When the component 100 is not in its final orientation, the marked level patch 126 must align with a line of reference and/or a reference plane, for example, a ground surface in order to correctly align the alignment tool 102 relative to the component 100. In other words, when the marked level patch 126 aligns with the line of reference, the marked level patch 126 indicates a final and correct orientation of the alignment tool 102 relative to the component 100.

The marked level patch 126 is disposed proximal to the first end 110 of the frame 108. In the illustrated embodiment of FIG. 3A, the marked level patch 126 includes a patch on which the text “LEVEL” may be written to indicate the correct alignment of the alignment tool 102 relative to the component 100. For example, a user may determine the correct alignment of the alignment tool 102 by visually looking at the marked level patch 126. However, in some examples, the marked level patch 126 may include any other text or icon instead of the text “LEVEL” to indicate the alignment of the alignment tool 102 relative to the component 100 when the component 100 is not in its final orientation.

The alignment tool 102 includes a level gauge 128 coupled to the frame 108 to further indicate a horizontal alignment of the alignment tool 102 relative to the component 100 when the component 100 is not in its final orientation. The level gauge 128 is disposed proximal to the second end 112 of the frame 108. The level gauge 128 is coupled with the frame 108 via a pair of third fasteners 136.

The alignment tool 102 further includes one or more magnets 130 coupled to the front surface 132 of the frame 108. In an example, the one or more magnets 130 removably couple the frame 108 with the component 100 before the one or more first retaining pins 144 engage the frame 108 of the alignment tool 102 with the component 100. The alignment tool 102 further includes one or more second fasteners 134. The one or more second fasteners 134 removably couple the one or more magnets 130 with the frame 108.

In the illustrated embodiment of FIG. 3A, the alignment tool 102 includes a single magnet 130 and a pair of second fasteners 134. Alternatively, the alignment tool 102 may include any number of magnets 130 based on factors such as, but not limited to, a size and a weight of the alignment tool 102. The magnet 130 has a rhombus shape herein. In other examples, the magnet 130 may have any other shape, without any limitations. The pair of second fasteners 134 are received into a pair of second openings (not shown) defined in the frame 108 of the alignment tool 102 to removably couple the magnet 130 with the frame 108. Particularly, the magnet 130 defines a pair of third openings (not shown). One third opening is defined at an end 140 of the magnet 130 and another third opening is defined at an end 142 of the magnet 130. When the second opening defined in the frame 108 is in alignment with a corresponding third opening, a corresponding second fastener 134 is received in the second opening and the corresponding third opening to removably couple the magnet 130 with the frame 108.

In an example, after removably coupling the frame 108 with the component 100 via the magnet 130, the first retaining pin 144 is received into the opening 107 defined in the component 100 such that the frame 108 is rotatable relative to the first retaining pin 144 until the alignment tool 102 correctly aligns relative to the component 100. Further, the second retaining pin 122 may move under a force of gravity and engage with the shoulder 124 of the component 100. In other words, the frame 108 is rotatable relative to the first retaining pin 144. Further, the first retaining pin 144 is designed to fit into the opening 107 in the component 100. Particularly, the first retaining pin 144, the magnet 130, and the second retaining pin 122 may stop all motion of the frame 108 except for an upward rotation. Furthermore, the second retaining pin 122 is designed to rest on the component 100 such that the weight of the frame 108 and the marking tool 104 holds the frame 108 in place.

The frame 108 further defines a tool receiving portion 114. The tool receiving portion 114 at least partially receives the marking tool 104 (see FIG. 1). Further, the frame 108 defines a number of grooves 116 facing the tool receiving portion 114. The number of grooves 116 at least partially receive the marking tool 104 to engage the marking tool 104 with the frame 108. In the illustrated embodiment of FIG. 3A, three grooves 116 are defined in the frame 108 to at least partially receive the marking tool 104. Alternatively, the frame 108 may define any number of grooves 116, based on application attributes.

In an example, when the component 100 is out of position or not in its final orientation, the marked level patch 126 and/or the level gauge 128 must align with the line of reference and/or the reference plane so that when component 100 is brought to its final orientation, the marking done by marking tool 104 is aligned correctly.

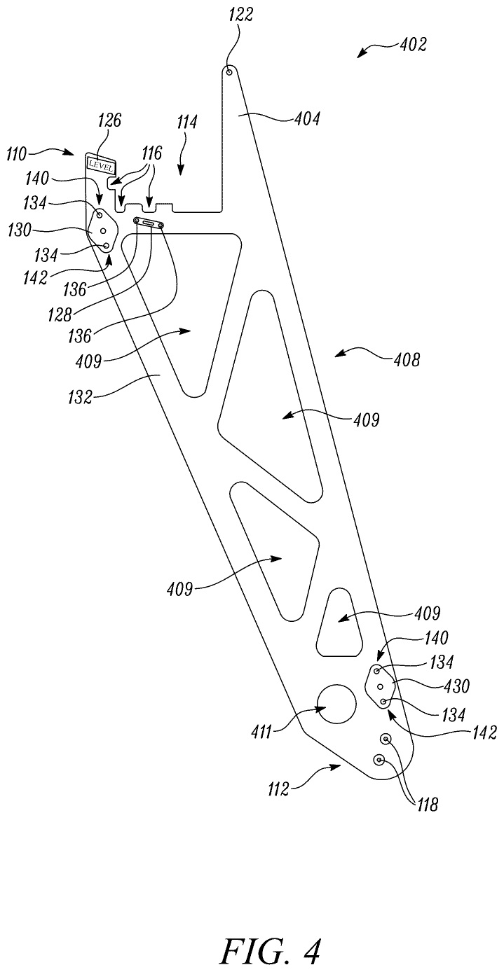

Referring to FIG. 4, a schematic view of an alignment tool 402 is illustrated, according to another example of the present disclosure. The alignment tool 402 is substantially similar to the alignment tool 102 of FIG. 3A with common components being referred to by the same numerals. The alignment tool 402 includes a frame 408. The frame 408 of the alignment tool 402 includes the truss-shaped design herein. Further, the frame 408 defines a number of through-openings 409, 411 between the first end 110 and the second end 112 of the frame 408. The through-openings 409 are triangular in shape herein and the through-opening 411 is circular in shape herein. The through-openings 409, 411 may reduce a weight of the alignment tool 402. It should be noted that the through-openings 409, 411 may have any other shape. Further, the alignment tool 402 includes a protruding portion 404. The protruding portion 404 extends beyond the first end 110 of the frame 408.

Further, a first retaining pin (not shown but substantially similar to the first retaining pin 144 shown in FIG. 3B) is disposed proximal to the second end 112 of the frame 108. Thus, the one or more first fasteners 118 are disposed proximal to the second end 112 of the frame 408 to removably couple the first retaining pin with the frame 408. Further, the second retaining pin 122 is disposed proximal to the first end 110 and is distal from the second end 112. Specifically, the second retaining pin 122 is disposed in the protruding portion 404 of the alignment tool 102. The second retaining pin 122 is disposed at a topmost end of the frame 408.

Moreover, the alignment tool 402 includes two magnets 130, 430 to removably couple the frame 408 with the component 100. One of the magnets 130 is disposed proximal to the first end 110 of the frame 408 and another magnet 430 is disposed proximal to the second end 112 of the frame 408. It should be noted that the magnets 130, 430 are similar to each other in shape and construction. Further, the level gauge 128 is disposed proximal to the first end 110 of the frame 408.

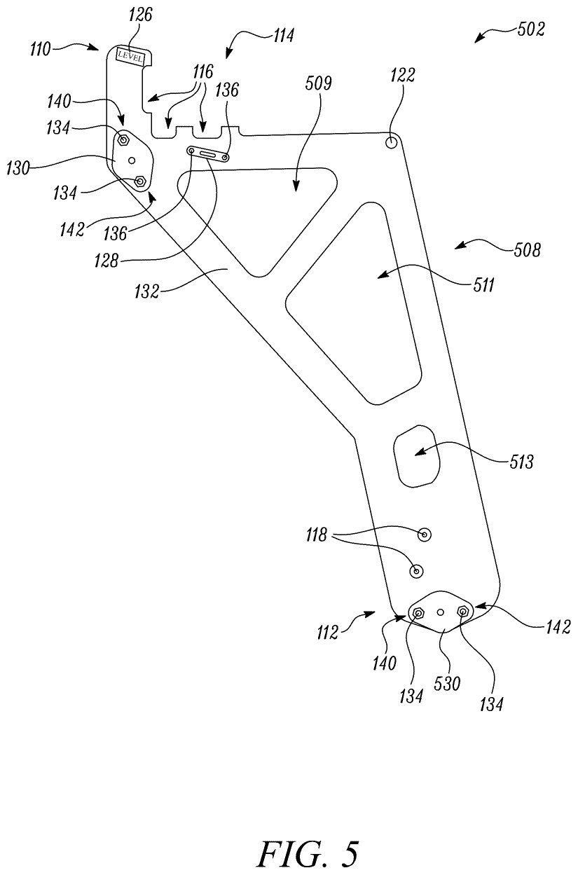

Referring to FIG. 5, a schematic view of an alignment tool 502 is illustrated, according to yet another example of the present disclosure. The alignment tool 502 is substantially similar to the alignment tool 102 with common components being referred to by the same numerals. The alignment tool 502 includes a frame 508. The frame 508 of the alignment tool 502 includes the truss-shaped design herein. Further, the frame 508 defines a number of through-openings 509, 511, 513 between the first end 110 and the second end 112 of the frame 508. The through-opening 509 is triangular in shape, the through-opening 511 is polygonal in shape, and the through-opening 513 is rectangular in shape. The through-openings 509, 511, 513 may reduce a weight of the alignment tool 502. It should be noted that the through-openings 509, 511, 513 may have any other shape.

Further, a first retaining pin (not shown but substantially similar to the first retaining pin 144 shown in FIG. 3B) is disposed proximal to the second end 112 of the frame 108. Further, the second retaining pin 122 is disposed proximal to the first end 110 and is distal from the second end 112. Moreover, the alignment tool 502 includes two magnets 130, 530 to removably couple the frame 508 with the component 100. One of the magnets 130 is disposed proximal to the first end 110 of the frame 508 and another magnet 530 is disposed at the second end 112 of the frame 508. It should be noted that the magnets 130, 530 are similar to each other in shape and construction. Further, the level gauge 128 is disposed proximal to the first end 110 of the frame 508.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the alignment tool 102, 402, 502. The alignment tool 102, 402, 502 engages with the marking tool 104 to mark the serial numbers or the text on the component 100, which may help in easy identification of the component 100, tracking of the component 100, and inventory management of the component 100. Further, the alignment tool 102, 402, 502 may prevent crooking of the serial numbers or the text on the component 100 based on a firm retention of the alignment tool 102, 402, 502 on the component 100. A design of the alignment tool 102, 402, 502 described herein may prevent any inadvertent shifting of the alignment tool 102, 402, 502 during an ongoing marking process. Further, when the component 100 is not correctly positioned or is out of position, the alignment tool 102, 402, 502 may allow the operator to determine if the marking tool 104 is correctly aligned to ensure accurate marking on the component 100.

The alignment tool 102, 402, 502 includes the first retaining pin 144, the second retaining pin 122, and the magnets 130, 430, 530 to retain the frame 108, 408, 508 of the alignment tool 102, 402, 502 on the component 100. The magnets 130, 430, 520 may prevent a movement of the alignment tool 102, 402, 502 along a Z axis (see FIGS. 1 and 2). Further, each of the first retaining pin 144 and the second retaining pin 122 may allow the alignment tool 102, 402, 502 to move along an X-axis (see FIGS. 1 and 2) and a Y-axis (see FIGS. 1 and 2) thereby allowing the user to correctly orient or position the alignment tool 102, 402, 502 relative to the component 100. Further, the alignment tool 102, 402, 502 moves under the force of gravity to properly engage and position the alignment tool 102, 402, 502 on to the component 100. Moreover, the alignment tool 102, 402, 502 may eliminate a requirement of an individual to continuously monitor the position and/or alignment of the alignment tool 102, 402, 502 relative to the component 100 during the marking process.

The alignment tool 102, 402, 502 may ensure readable and consistent marking of, for example, serial numbers or texts, thereby preventing confusion to the user. Further, the alignment tool 102, 402, 502 is simple in design, may be used in a variety of applications, and may improve operator's confidence during the marking process. The alignment tool 102, 402, 502 may be cost-effective and may be used to mark various components. The alignment tool 102, 402, 502 may ensure that the marking tool 104 is positioned correctly and therefore helps in reducing errors during the marking process while improving precision of the marking of the serial numbers or the text on the component 100.

Furthermore, the alignment tool 102, 402, 502 includes the marked level patch 126 and the level gauge 128 to maintain consistent alignment between the marking tool 104 and the component 100 being marked when the component 100 is not in its final orientation, which may in turn ensure accurate marking every time. The marked level patch 126 is planar to a floor and may visually depict to an operator whether the alignment tool 102, 402, 502 and/or the marking tool 104 are properly leveled or not. Further, the level gauge 128 may allow the operator to use the alignment tool 102, 402, 502 for repair work when existing locator points may have shifted. The alignment tool 102, 402, 502 is designed to secure the marking tool 104 in an in-process orientation. The marking tool 104 may then be left to allow the operator to continue work in a different area.

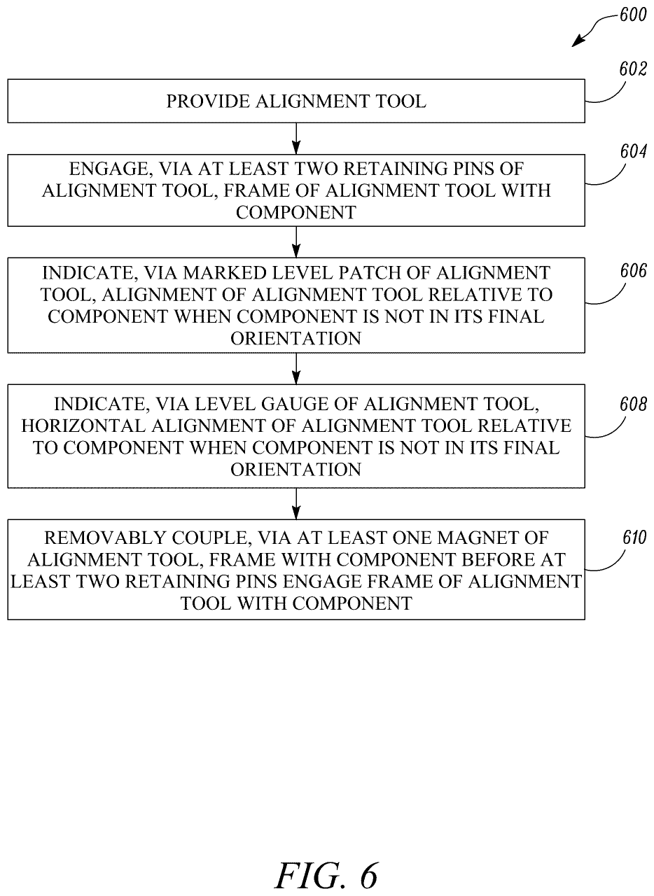

Referring to FIG. 6, a flowchart for a method 600 of coupling the alignment tool 102, 402, 502 with the component 100 for marking the component 100 is illustrated. With reference to FIGS. 1 to 6, at step 602, the alignment tool 102, 402, 502 is provided. The alignment tool 102, 402, 502 includes the frame 108, 408, 508.

At step 604, the frame 108, 408, 508 of the alignment tool 102, 402, 502 is engaged with the component 100 via the two or more retaining pins 144, 122 of the alignment tool 102, 402, 502. The two or more retaining pins 144, 122 include the first retaining pin 144 that is coupled to the rear surface 133 of the frame 108, 408, 508 and the second retaining pin 122 extending from the rear surface 133 of the frame 108, 408, 508. The step 604 further includes a step at which the alignment tool 102, 402, 502 is allowed to move under the force of gravity until the second retaining pin 122 engages with the shoulder 124 of the component 100.

At step 606, the alignment of the alignment tool 102, 402, 502 relative to the component 100 when the component 100 is not in its final orientation is indicated via the marked level patch 126 of the alignment tool 102, 402, 502. At step 608, the horizontal alignment of the alignment tool 102, 402, 502 relative to the component 100 when the component 100 is not in its final orientation is indicated via the level gauge 128 of the alignment tool 102, 402, 502. The level gauge 128 is coupled to the frame 108, 408, 508. At step 610, the frame 108 is removably coupled with the component 100 via the one or more magnets 130, 430, 530 of the alignment tool 102 before the two or more retaining pins 144, 122 engage the frame 108 of the alignment tool 102 with the component 100. The one or more magnets 130, 430, 530 are coupled to the front surface 132 of the frame 108.

The frame 108, 408, 508 defines the tool receiving portion 114. The method 600 includes a step (not shown) at which the marking tool 104 is at least partially received within the tool receiving portion 114 defined by the frame 108, 408, 508. The method 600 further includes a step (not shown) at which the marking tool 104 is engaged with the frame 108, 408, 508. The method 600 further includes a step (not shown) at which the serial numbers or the text are marked on the component 100 when the marking tool 104 is engaged with the frame 108, 408, 508.

It should be noted that the steps 602, 604, 606, 608, 610 of the method 600 may be performed in a sequence that is different from that explained in relation to FIG. 6. Further, various steps 602, 604, 606, 608, 610 can be performed together.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

What is claimed is:

1. An alignment tool usable for marking a component, the alignment tool comprising:
a frame;
at least two retaining pins that are adapted to engage the frame of the alignment tool with the component;
a marked level patch to indicate an alignment of the alignment tool relative to the component when the component is not in its final orientation; and
at least one magnet coupled to a front surface of the frame, wherein the at least one magnet is adapted to removably couple the frame with the component.

2. The alignment tool of claim 1, wherein the at least two retaining pins include a first retaining pin that is coupled to a rear surface of the frame.

3. The alignment tool of claim 2 further comprising at least one first fastener, wherein the at least one first fastener removably couples the first retaining pin with the frame.

4. The alignment tool of claim 2, wherein the at least two retaining pins include a second retaining pin extending from the rear surface of the frame.

5. The alignment tool of claim 1 further comprising at least one second fastener, wherein the at least one second fastener removably couples the at least one magnet with the frame.

6. The alignment tool of claim 1, wherein the frame includes a truss-shaped design or an L-shaped profile.

7. The alignment tool of claim 1 further comprising a level gauge coupled to the frame to further indicate a horizontal alignment of the alignment tool relative to the component when the component is not in its final orientation.

8. The alignment tool of claim 1, wherein the frame is adapted to engage with a marking tool for marking serial numbers or text on the component.

9. The alignment tool of claim 8, wherein the frame defines a tool receiving portion that is adapted to at least partially receive the marking tool.

10. The alignment tool of claim 9, wherein the frame defines a plurality of grooves facing the tool receiving portion, wherein the plurality of grooves are adapted to at least partially receive the marking tool to engage the marking tool with the frame.

11. An alignment tool usable for marking a component, the alignment tool comprising:
a frame adapted to engage with a marking tool to mark serial numbers or text on the component, and wherein the frame defines a tool receiving portion that is adapted to at least partially receive the marking tool;
at least two retaining pins that are adapted to engage the frame of the alignment tool with the component;
a marked level patch to indicate an alignment of the alignment tool relative to the component when the component is not in its final orientation;
a level gauge coupled to the frame to further indicate a horizontal alignment of the alignment tool relative to the component when the component is not in its final orientation; and
at least one magnet coupled to a front surface of the frame, wherein the at least one magnet is adapted to removably couple the frame with the component.

12. The alignment tool of claim 11, wherein the at least two retaining pins include a first retaining pin that is coupled to a rear surface of the frame.

13. The alignment tool of claim 12 further comprising at least one first fastener, wherein the at least one first fastener removably couples the first retaining pin with the frame.

14. The alignment tool of claim 12, wherein the at least two retaining pins include a second retaining pin extending from the rear surface of the frame.

15. The alignment tool of claim 11 further comprising at least one second fastener, wherein the at least one second fastener removably couples the at least one magnet with the frame.

16. The alignment tool of claim 11, wherein the frame includes a truss-shaped design or an L-shaped profile.

17. The alignment tool of claim 11, wherein the frame defines a plurality of grooves facing the tool receiving portion, wherein the plurality of grooves are adapted to at least partially receive the marking tool to engage the marking tool with the frame.

18. A method of coupling an alignment tool with a component for marking the component, the method comprising:
providing the alignment tool, wherein the alignment tool includes a frame;
engaging, via at least two retaining pins of the alignment tool, the frame of the alignment tool with the component;
indicating, via a marked level patch of the alignment tool, an alignment of the alignment tool relative to the component when the component is not in its final orientation;
indicating, via a level gauge of the alignment tool, a horizontal alignment of the alignment tool relative to the component when the component is not in its final orientation, wherein the level gauge is coupled to the frame; and
removably coupling, via at least one magnet of the alignment tool, the frame with the component before the at least two retaining pins engage the frame of the alignment tool with the component, wherein the at least one magnet is coupled to a front surface of the frame.

19. The method of claim 18, wherein the at least two retaining pins include a first retaining pin that is coupled to a rear surface of the frame and a second retaining pin extending from the rear surface of the frame, wherein engaging the frame of the alignment tool with the component further includes allowing a movement of the alignment tool under a force of gravity until the second retaining pin engages with a shoulder of the component.

20. The method of claim 18, wherein the frame defines a tool receiving portion, the method further comprising:
at least partially receiving a marking tool within the tool receiving portion defined by the frame;
engaging the marking tool with the frame; and
marking serial numbers or text on the component when the marking tool is engaged with the frame.
